(19) United States
(12) Patent Application Publication
(10) Pub. No.: US 2010/0189875 A1
(43) Pub. Date: Jul. 29, 2010

(54) USE OF WHOLE GRAIN MATERIALS WITH HIGH RESISTANT STARCH FOR SATIETY, REDUCTION OF FOOD INTAKE AND WEIGHT MANAGEMENT

(75) Inventor: Eugene Terry Finocchiaro, West Amwell, NJ (US)

Correspondence Address: National Starch LLC;Patent Dept. Karen Kaiser, 10 Finderne Avenue, Bridgewater, NJ, 08807-0500, US

(73) Assignee: Brunob II B.V.

(21) Appl. No.: 12/687,350

(22) Filed: Jan. 14, 2010

Related U.S. Application Data
(60) Provisional application No. 61/148,247, filed on Jan. 29, 2009.

(51) Int. Cl. A23L 1/0522

(52) U.S. Cl. 426/661

(57) ABSTRACT

This invention relates to the use of whole grain products high in resistant starch content to increase satiety in mammals. The invention further relates to the management of weight by increasing such satiety. The whole grain products may be added to foods, and the enhancement may be achieved while not significantly sacrificing organoleptic quality characteristics of the food, including texture and flavor yet increasing the nutritional value.

This application claims priority to provisional application U.S. Ser. No. 61/148,247 filed 29 Jan. 2009.

### BACKGROUND OF THE INVENTION

The present invention relates to the use of whole grain products that are high in resistant starch (RS) to increase the extent and duration of satiety in mammals. The invention further relates to the reduction of food intake and/or management of weight by increasing such satiety.

Different foods provide different satiety or lack of hunger impressions. In other words, a mammal who consumes equal-energy portions of different food items may feel stronger sensations of satiety or lack the desire to eat. Consequently, after consuming increased or higher satiety foods, the mammal may forgo or delay eating additional portions or consume smaller portions, thereby reducing the total number of calories that are consumed. Thus, increased or higher satiety food items may partially reduce the quantity of food a mammal consumes and contribute to healthier diets, thereby assisting with weight control and reducing the risk of diabetes, heart disease, certain cancers and other weight-related disorders.

### SUMMARY OF THE INVENTION

This invention relates to the use of whole grain products that are high in resistant starch (RS) to increase satiety in mammals. One source of such whole grain products are high amylose whole grain products. The invention further relates to the management of weight and/or reduction of food intake by increasing the extent and duration of such satiety effect. The whole grain products may be added to foods, and the enhancement may be achieved while not significantly sacrificing organoleptic quality characteristics of the food, including texture and flavor yet increasing the nutritional value.

The term “whole grain product” or “wholegrain product”, as used herein, is intended to not only include the cereal grain itself, but also is intended to include those which have been partially processed by methods well known in the art including, for example, dry milled grains such as grits, meals, kernels and flour. It is not intended to include whole grains which have been processed to remove part of the grain, such as starch.

The term “total dietary fiber content” (“TDF”) may include the polysaccharides and remnants of plant materials that are resistant to hydrolysis (digestion) by human alimentary enzymes, including nonstarch polysaccharides, resistant starch, lignanin and minor components such as waxes, cutin and suberin. As used herein, TDF is defined as measured by the weight of undigested material separated by filtration as described by the test described as AOAC method 991.43.

The term “resistant starch (RS)” is defined as the sum of starch and starch degradation products that are not absorbed in the small intestine of healthy individuals and may be measured by a variety of tests known in the art. Resistant starch is defined herein as measured by treatment with pancreatic alpha amylase and amyloglucosidase (AMG) using a modification of the Englyst method, described herein. High resistant starch content is intended to mean a resistant starch content of at least 40% by weight based on the weight of the starch.

The term “high amylose” is used herein, is defined as containing at least 27% amylose for wheat or rice and at least 50% amylose for other sources and, for sources other than wheat or rice, in one embodiment contains at least 70%, in another embodiment particularly at least 80%, and in yet another embodiment at least 90% amylase by weight based on the starch within the whole grain. The percent amylose is determined by using the potentiometric test described, infra.

Increased satiety, as used herein, is intended to mean the enhancement of satiety as measured by clinical cognitive measures known to those skilled in the art. More specifically, it is intended to mean that the caloric intake within at least two hours after consumption of the food containing the whole grain product is significantly reduced compared to consumption of a food of equal caloric content which whole grain product is substituted by readily digestible starch.

Mammal, as used herein, is intended to include humans.

### DETAILS OF THE INVENTION

This invention relates to the use of high resistant starch whole grain products to increase satiety in mammals. The invention also relates to the reduction of caloric intake as a consequence of inducing satiety, both of which will aid in the management of weight.

The whole grain may be any native grain derived from any native source which is high is amylose. A native grain as used herein, is one as it is found in nature. Also suitable are grains derived from a plant obtained by standard breeding techniques including crossbreeding, translocation, inversion, transformation or any other method of gene or chromosome engineering to include variations thereof. In addition, grain derived from a plant grown from induced mutations and variations of the above generic composition which may be produced by known standard methods of mutation breeding are also suitable herein.

Typical sources for the base grains are cereals including wheat, corn (maize), rice, barley, rye, and sorghum varieties which are high in amylose and in one embodiment is high amylose corn and in another embodiment is high amylose corn having an amylose content of at least 70%.

Another useful base grain containing high amylase starch is extracted from a plant source having an amylose extender genotype, the component starch comprising less than 10% by weight amylopectin. This grain is derived from a plant breeding population, particularly corn, which is a genetic composite of germplasm selections and its starch comprises at least 75% by weight amylose, optionally at least 85% amylose (i.e., normal amylose) as measured by butanol fractionation/exclusion chromatography techniques. The starch further comprises less than 10%, by weight, optionally less than 5%, amylopectin and additionally from about 8 to 25% low molecular weight amylose. The grain is preferably derived from a plant having a recessive amylase extender genotype coupled with numerous amylose extender modifier genes. This grain and its method of preparation are described in U.S. Pat. No. 5,300,145, the specification of which is incorporated herein by reference.

The whole grain products of the present invention may be the base grain or the dry milled products derived therefrom. The whole grain products also include those which are modified by any method known in the art including those modifications which increase the total dietary fiber and/or resistant starch contents of the whole grains. In one embodiment, the whole grain product is heat moisture treated as described for example in U.S. Pat. Nos. 5,593,503 and 5,902,410 and US Publication Nos. 2002-0197373 and 2006-0263503, the specifications of which are incorporated herein by reference. In one embodiment, the predominant granular structure of the starch within the whole grain product is not completely destroyed though it may be partially swollen as long as its crystallinity is not completely destroyed. Accordingly, the term “granular starch” as used herein, means a starch which retains at least part of its granular structure thereby exhibiting some crystallinity, so that the granules are birefringent and the maltese cross is evident under polarized light according to the method described in U.S. Pat. No. 5,849,090.

In one embodiment of the invention, the whole grain product has a resistant starch content of at least 40%, in another embodiment at least 50%, in yet another embodiment at least about 60%, and in still yet another embodiment at least 70% by weight of the starch.

In one embodiment of the invention, the whole grain product has a total dietary fiber content of at least 20%, in another embodiment at least 30%, in yet another embodiment at least 40%, in still yet another embodiment at least 50%, and in a further embodiment at least 60% by weight of the whole grain product.

The whole grain products of this invention may be consumed directly or used in any food or beverage product (hereinafter collectively referred to as foods). Typical food products include, but are not limited to, cereals such as ready-to-eat, puffed or expanded cereals and cereals which are cooked before eating; baked goods such as breads, crackers, cookies, cakes, muffins, rolls, pastries and other grain-based ingredients; pasta; beverages; fried and coated foods; snacks; and cultured dairy products such as yogurts, cheeses, and sour creams. Food products is also intended to include nutritional products, including but not limited to, prebiotic and synbiotic compositions, diabetic foods and supplements, dietetic foods, foods to control glycemic response, and tablets and other pharmaceutical dosage forms. A prebiotic composition is a nondigestible food ingredient that beneficially affects the host by selectively stimulating the growth, activity or both of one or a limited number of bacterial species already resident in the colon. A synbiotic composition may be a yogurt, capsule or other form of introduction into the host animal, including human beings, in which prebiotics are used in combination with a live microbial food supplement. The live microbial food supplement beneficially affects the host animal by improving its intestinal microbial balance.

The whole grain product is added in an amount such that one serving of the food is effective to increase satiety, yet retain good organoleptic properties in the food and not cause significant gastro-intestinal stress, and in one case is added in an amount of at least 15 g/serving, in others at least 20 g, 25 g, 30 g, 35 g, 40 g, 45 g or 50 g per serving, yet no more than 60 g per serving. In one aspect of the invention, the whole grain product is added as a substitute in a food for at least part of the non-whole grain or non-high amylose carbohydrate product, for example, by replacing the starch or grain, grit, kernel, meal or flour which is not high in resistant starch content. In another aspect of the invention, the whole grain product is added to replace at least 15%, 20%, 25%, 30%, 35%, 40%, 45% or 50% of the carbohydrate in the product.

Addition of the whole grain products to foods does not significantly affect the organoleptic quality characteristics of the food in any deleterious way, including texture and flavor, and in some cases provides favorable organoleptic changes. Further, the addition of the whole grain products to foods may increase the nutritional value of the food, particularly the dietary fiber content.

Consumption of the whole grain product in a food results in increased satiety by at least 12%, in another embodiment at least 14% and in yet another embodiment at least 16%. Such decreased caloric intake may further result in increased weight loss.

Increasing post meal satiety would be an important benefit in helping a mammal lose weight by lengthening the interval between food intake and/or decreasing the amount of food consumed at each meal, thereby reducing additional consumption of calories (daily caloric intake).

### EXAMPLES

The following examples are presented to further illustrate and explain the present invention and should not be taken as limiting in any regard. All parts, ratios, and percentages are given by weight and all temperatures in degrees Celsius (° C.) unless otherwise noted.

The following ingredients were used throughout the examples.

High dextrose equivalent (DE) dextrin, STAR-DRI® 100, commercially available from Tate and Lye, located in Decatur, Ill., was tested as a rapidly digestible starch (RDS) control.

Hi-maize® 260 starch, a high RS, high TDF, high amylose, heat-moisture treated starch commercially available from National Starch LLC was used as a high RS starch reference.

Hi-maize® whole grain corn flour, a high amylose, high RS processed flour commercially available from National Starch LLC was used as a high resistant starch whole grain product.

The following test procedures were used throughout the examples.

Resistant Starch (“RS”) Determination (Modified Englyst Method).

RS was determined using a modified version of the Englyst Digestion Method (Englyst et. al., European Journal of Clinical Nutrition, vol. 46 (Suppl. 2), pp S33-S50, 1992). The procedure and modifications are detailed below. Resistant starch (RS) is the starch not hydrolyzed after 120 minutes of incubation. RS content is determined indirectly by measuring the amount of digested carbohydrate (i.e., free glucose) after 120 min of incubation, then calculating RS by subtracting the amount of free glucose from carbohydrate to give % RS based on the carbohydrate content.

### A1. Preparation of Standard Solutions, Enzyme Solutions, Blanks and Glucose Controls:

a. Reaction “blank’ consisted of 20 ml of 0.25 M sodium acetate.
b. Glucose standard consisted of 20 ml 0.25M sodium acetate buffer plus 500 mg glucose.
c. Stock solution A. Dissolve 0.5% (w/v) pepsin (porcine stomach mucosa (P 7000) from Sigma) plus 0.5% (w/v) guar gum (G-4129 guar gum from Sigma) in 0.05M HCl.
d. Preparation of purified pancreatic enzyme solution: 12 g of porcine pancreatin (Sigma) was dissolved in 85 mls of de-ionized room temperature water. The solution was subsequently centrifuged (3000 rpm, 10 min, 50 ml tubes) and the supernatant was decanted off and saved.
e. Stock solution B was prepared by adding 40 mg of dry invertase (Sigma) and 1.0 ml amyloglucosidase (AMG) (300 L AMG from Novozymes) to the aforementioned supernatant.

### A2. Determination of RS Content (Modified Englyst Protocol):

Each test sample was weighed (to the nearest 0.1 mg) to deliver 550-600 mg of carbohydrate in each test tube. 10 ml of solution A was then added to each test tube. Samples were covered tightly, mixed, and then incubated in a quiescent water bath @ 37° C. for 30 minutes. Ten mls of 0.25M sodium acetate buffer was added to neutralize the solution. Next, 5 mls of enzyme mixture (solution B) was added to the samples, blank, and glucose tubes @ 20-30 sec. intervals, and placed into the 37° C. water bath for digestion. Tubes were shaken horizontally during digestion. At 120 minutes of reaction time, 0.5-ml aliquots were removed and placed into separate tubes of 19 mls of 66% ethanol to stop the reaction (Enzyme will precipitate, re-disperse before next step). 1.0 ml aliquot of the ethanolic solution was then pipetted into 1 ml micro-centrifuge tubes and centrifuged 5 min @ 3000 g. Glucose concentrations were subsequently measured using the glucose oxidase/peroxidase (GOPOD) method. (Megazyme Kit K-Gluc). Three ml of GOPOD was placed into each culture tube and 0.1 ml of each sample was added, mixed well and incubated for 20 minutes at 50° C. Free glucose was determined spectrophotometrically for absorbance at 510 nm wavelength. The percent glucose (digestion) for each sample is calculated based on the UV absorbance relative to the standards. Routine controls were run that included a reference sample of regular dent corn. All analyses were run at least in duplicates.

### B. Total Dietary Fiber Determination (“TDF”) Using AOAC 991.43 Method.

Total dietary fiber (TDF) was determined using the Megazyme-K-TDFR diagnostic kit recommended for AOAC Official Method 991.43. Duplicate samples (1.0 g dry basis) were dispersed in 0.05M MES/TRIS buffer solution (40 ml, pH 8.2) in 400 ml tall-form beaker and a heat stable alpha-amylase solution (50 μl) was added. The mixture was incubated in the shaking water bath at 98 C. for 35 minutes. After cooling to 60 C., the mixture was treated with protease enzyme (100 μl) and incubated for 30 minutes. The digest was adjusted to pH 4.5 with HCL solution. Then Glucoamylase (200 μl) was added and the mixture was digested for another 30 minutes at 60 C. An insoluble residue was precipitated by adding 4 volumes of 95% ethanol. The residue was collected on packed filter, dried overnight at 105 C., weighed and calculated as total dietary fiber (minus the protein and ash contents in residue). All TDF data reported on dry basis.

### C. Moisture Content (“M %”) Determination

The moisture content of the grains (ground to a particle size of less than 355 microns) was determined by the CENCO moisture balance (balance set to 125 Watts on infrared, available from CSC Scientific Co., Inc.). To avoid charring of the samples, the temperature in the moisture balance was set to 70° C. The readings obtained by this method are within 0.6% of absolute when checked against an oven moisture analysis method (AACC method 44-15A for corn grits).

### D. Amylose Content by Potentiometric Titration

0.5 g of a starch (1.0 g of a ground grain) sample was heated in 10 mls of concentrated calcium chloride (about 30% by weight) to 95° C. for 30 minutes. The sample was cooled to room temperature, diluted with 5 mls of a 2.5% uranyl acetate solution, mixed well, and centrifuged for 5 minutes at 2000 rpm. The sample was then filtered to give a clear solution.

The starch concentration was determined polarimetrically using a 1 cm polarimetric cell. An aliquot of the sample (normally 5 mls) was then directly titrated with a standardized 0.01 N iodine solution while recording the potential using a platinum electrode with a KCl reference electrode. The amount of iodine needed to reach the inflection point was measured directly as bound iodine. The amount of amylose was calculated by assuming 1.0 gram of amylose will bind with 200 milligrams of iodine.

### Example 1

### RS and TDF Analysis of Test Materials

Test starches and whole grain flour were assayed for RS and TDF content using assays mentioned above. Table 1 provides a brief sample description and summary of analytical data.

TABLE 1
Summary of Relevant Experimental Data.

| | | | | % RS ² | % TDF ³ |
|---|---|---|---|---|---|
| | Base | | Commercial | (dry | (dry |
| Description | Ingredient | Process | Ingredient | basis) | basis) |
| Maltodextrin | Starch | Dextrinization | STAR-DRI ® 100 ¹ | <1 | <1 |
| High RS, high | High | Heat-moisture | Hi-maize ® 260 ¹ | 52 | 60 |
| amylose | amylose | treatment | | | |
| starch | starch | | | | |
| High RS | High | Dry milling | Hi-maize ® Whole | 60 | 31 |
| whole grain | amylose corn | | grain flour ¹ | | |
| corn flour | grains | | | | |

¹ = tested in satiety/caloric reduction clinical trial (see table 2 below).
² = RS reported as % of total carbohydrate (whole grain flour is 73% carbohydrate)
³ = TDF reported as % of total ingredient

### Example 2

### Clinical Trials

16 healthy males of age 20-30 years and normal EMI were recruited as panelists. A randomized repeated measure design was used. Subjects were fed a standardized breakfast four hours before consuming test materials. They then consumed, in randomized order, a tomato flavored soup containing 50 g of test starch (dry basis) or the tomato soup alone. Food intake was measured from an ad libitum pizza test meal consumed two hours after ingestion of the tomato soup alone or the soup containing the test starches. Clinical data has shown un-expected satiety impact of whole grain vs. pure RS starch and rapidly digested starch (RDS) controls. The RS starch sample enabled a 9.1%% reduction in food intake, whereas the high RS whole grain sample enabled a 17.7% reduction in food intake. Clinical outcome is illustrated in Table 2.

TABLE 2
Summary of Relevant Clinical Data.

| Test dose (50 g (db)) in | Caloric intake from ad | % Caloric |
|---|---|---|
| tomato soup fed four hours | libitum meal (2 hrs | reduction |
| after breakfast | after test dose)* | (vs. control) |
| Control | 1511 kcal^{a} | n/a |
| (no test starch, soup only) | | |
| STAR-DRI ® 100 | 1424^{ac} | 5.8 |
| (rapidly digested starch) | | |
| Hi-maize ® 260 starch | 1374^{c} | 9.1 |
| (high RS starch) | | |
| Hi-maize whole grain corn | 1243^{b} | 17.7 |
| flour | | |
| (high RS whole grain) | | |

*Different superscripts are significant different (P < 0.0001, n = 16)

The clinical outcome of the high RS whole grain corn flour is significant and unexpected in that the existing body of evidence would not predict such a large reduction in food intake from high RS whole grain products.

1. A food comprising a satiety-effective amount of a whole grain product with a high resistant starch content.

2. The food of claim 1, wherein the whole grain product is present in an amount of at least 15 g per serving of the food.

3. (canceled)

4. (canceled)

5. (canceled)

6. (canceled)

7. (canceled)

8. (canceled)

9. The food of claim 8, wherein the whole grain product is present in an amount of at least 50 g per serving of the food.

10. The food of claim 8, wherein the whole grain product is present in an amount of no more than 60 g per serving of the food.

11. The food of claim 1, wherein the whole grain product is selected from the group consisting of grain, grits, kernels, flour, meal, and mixtures thereof.

12. The food of claim 1, wherein the whole grain product has a resistant starch content of at least 40% by weight of starch within the whole grain product.

13. (canceled)

14. The food of claim 12, wherein the whole grain product has a resistant starch content of at least 60% by weight of starch within the whole grain product.

15. The food of claim 1, wherein the whole grain product is selected from the group consisting of wheat, corn, rice, barley, rye, and sorghum.

16. The food of claim 15, wherein the whole grain product has an amylose content of at least 27% amylose for wheat or rice and at least about 50% amylose for other sources, by weight based on starch within the whole grain product.

17. (canceled)

18. The food of claim 17, wherein the whole grain product has an amylose content of at least 80%.

19. The food of claim 1, wherein the whole grain product is heat-moisture treated.

20. The food of claim 1, wherein the whole grain product has a total dietary fiber content of at least 20% by weight of the whole grain product.

21. (canceled)

22. The food of claim 1, wherein starch within the whole grain is predominantly in granular form.

23. (canceled)

24. (canceled)

25. (canceled)

26. A method for increasing satiety in a mammal, the method comprising administering to the mammal the food of claim 1.

27. The method of claim 26, wherein satiety is increased by at least 12%.

28. (canceled)

29. The method of claim 28, wherein satiety is increased by at least 16%.

30. A method of preventing or treating obesity in a mammal, the method comprising administering to the mammal the food of claim 1.

31. A method of reducing the caloric intake by a mammal, the method comprising administering to the mammal the food of claim 1.

32. A method of producing a feeling of satiety in a mammal, the method comprising administering to the mammal the food of claim 1.

33. (canceled)

34. A process of making the food of claim 1 comprising substituting at least 15 grams of a whole grain product high in resistant starch content for an equal amount of an ingredient selected from the group consisting of starch, non-high resistant starch grain, non-high resistant starch grits, non-high resistant starch kernels, non-high resistant starch flour, non-high resistant starch meal, and mixtures thereof.
